(19) United States
(12) Patent Application Publication
(10) Pub. No.: US 2021/0093042 A1
(43) Pub. Date: Apr. 1, 2021

(54) Upper for a Shoe

(71) Applicant: Mizuno Corporation, Osaka-shi (JP)

(72) Inventors: Takuto MASUDA, Osaka-shi (JP); Toshiyasu YASUI, Osaka-shi (JP); Yuichi SHIMIZU, Osaka-shi (JP)

(21) Appl. No.: 17/032,388

(22) Filed: Sep. 25, 2020

(30) Foreign Application Priority Data
Sep. 30, 2019 (JP) 2019-178156

(51) Int. Cl. A43B 23/02; A43B 5/02; B32B 27/06; B32B 7/12; B32B 38/00

(52) U.S. Cl. CPC A43B 23/026; A43B 5/025; A43B 23/0215; A43B 23/021; A43B 23/0235; B32B 2255/26; B32B 27/06; B32B 7/12; B32B 38/145; B32B 2437/02; A43B 23/0255

(57) ABSTRACT

An upper for a shoe adapted to cover a foot of a shoe wearer includes a base fabric layer. The base fabric layer of the upper has a first upper material formed of natural leather and constituting a first upper area, and a second upper material formed of a material other than natural leather and constituting a second upper area. A surface material formed of resin film is fixedly attached on the base fabric layer. The surface material covers both the first and second upper materials so that an outer surface of the base fabric layer can be coated by one surface layer formed of the surface material.

### BACKGROUND OF THE INVENTION

The present invention relates generally to an upper for a shoe, and more particularly, to an improvement of a structure of the upper.

Japanese patent application No. 2005-273131 (hereinafter referred to as JP '131) discloses a leathery sheet of a sports shoe in which a polyurethane hotmelt resin layer as a skin layer is formed on a fibrous base material of natural leather or the like (see paras. [0001], [0019], and FIGS. 1, 2).

According to para. [0097] of JP '131, when manufacturing the above-mentioned leathery sheet, moisture curable polyurethane hotmelt resin composition is heat-melted, the resin composition in the state of heat-melting is applied on a mold-releasable substrate, which is bonded to the fibrous base material, such that thereby the leathery sheet is obtained in which the skin layer formed of the resin composition is formed on the fibrous base material (see FIGS. 1 and 2).

Generally, natural leather is superior in comfortableness, etc., but it is expensive. Therefore, recently, natural leather is used at a part of upper areas of a shoe and a material other than natural leather, e.g. textile material, is used at the other upper areas.

However, when disposing a material other than natural leather adjacent to natural leather, since colors/shades or texture/quality of both materials differ delicately from each other, variation in appearance quality occurs and thus a feeling of oneness of the entire upper is impaired. In this case, when trying to match a color of natural leather with a color of the material other than the natural leather, it takes a large amount of labor and time, thus greatly increasing a manufacturing cost. Moreover, in the case that a different skin layer (i.e. surface layer) is formed by natural leather and the material other than the natural leather, at the time of bonding to a sole of the shoe, a respectively different surface treatment is required, such that thereby a manufacturing process can be extremely complicated thus increasing a manufacturing cost.

The present invention has been made in view of these circumstances and its object is to provide an upper for a shoe that can prevent variation in appearance quality between different materials without increasing a manufacturing cost.

Other objects and advantages of the present invention will be obvious and appear hereinafter.

### SUMMARY OF THE INVENTION

An upper for a shoe according to the present invention is adapted to cover a foot of a shoe wearer and the upper includes abase fabric layer. The base fabric layer comprises a first upper material formed of natural leather and constituting a first upper area and a second upper material formed of a material other than natural leather and constituting a second upper area. The upper further includes a surface layer provided on an outer surface of the base fabric layer. The surface layer is formed of resin film and covers both the first and second upper materials. The outer surface of the base fabric layer is coated with the surface layer.

According to the present invention, as above-mentioned, the base fabric layer of the upper has the first upper material formed of natural leather and the second upper material formed of material other than natural leather, and the outer surface of the fabric layer is coated with one surface layer formed of resin film and covering both the first and second upper materials. Thereby, even in the event that variation in appearance quality occurs between a first area of the first upper material and a second area of the second upper material because the first and second areas are constructed by different materials, colors/shades or texture/quality of both the areas can be made equal by covering the outer surface of the base fabric layer, that is, the first and second upper materials, with one surface layer of resin film. As a result, variation in appearance quality between the first and second upper areas can be prevented. Moreover, in this case, there is no need to make a color-matching and texture-matching between the first and second upper materials, and all we have to do is to cover the first and second upper materials with one surface layer of resin film. Thereby, a manufacturing cost can be reduced.

On the outer surface of the second upper material coated with the surface layer, a resin layer other than the surface layer may not be formed. Thereby, the fixing strength of the surface layer relative to the second upper material and thus the outer surface of the base fabric layer can be improved, thus preventing separation of the surface layer.

The first and second upper materials may be joined together without overlapping with each other. Thereby, a boundary between the first and second upper materials can be prevented from becoming hard by overlapping both the materials. Also, in this case, even if both the materials are not overlapped with each other, the boundary between the first and second upper materials is coated or covered by the surface layer, thus increasing a binding strength of both the upper materials.

The surface layer may be fixedly attached (e.g. thermocompression-bonded, glued/bonded, etc.) to the outer surface of the base fabric layer, that is, the outer surface of the first and second upper materials that constitutes the base fabric layer. Thereby, the surface layer and the base fabric layer are integrated with each other to constitute a single leather sheet as a whole.

An outer peripheral shape of the surface layer coating the base fabric layer may correspond to an outer peripheral shape of the base fabric layer. In this case, the entire outer surface of the first and second upper materials are coated/covered by the surface layer.

An outer peripheral shape of the surface layer coating the base fabric layer may be smaller than an outer peripheral shape of the base fabric layer. Thereby, a portion of the outer peripheral shape of the base fabric layer, which is larger than the outer peripheral shape of the surface layer, can be used as a bonding margin relative to a sole of the shoe. In this case, an operation process such as a substrate treatment and the like relative to the outer surface of the base fabric layer is unnecessary in order to secure the bonding strength relative to the sole.

Another member may be interposed between the surface layer and the outer surface of the base fabric layer. In this case, an insertion of another member can make a protruding portion on an upper surface. For example, by forming such a protruding portion at an upper area of a shoe (e.g. a soccer shoe) where a shoe wearer wants to spin/rotate a soccer ball, a ball spin can be effectively achieved. Also, a design effect can be exhibited on the upper surface.

A method for manufacturing an upper for a shoe is provided. The upper is adapted to cover a foot of a shoe wearer and the upper includes a base fabric layer. In this method, firstly, as the base fabric layer of the upper, a first upper material formed of natural leather and constituting a first upper area and a second upper material formed of a material other than natural leather and constituting a second upper area are prepared. Secondly, the first and second upper materials are joined together and an outer surface of the joined first and second upper materials is coated with a surface layer formed of resin film.

According to the present invention, as above-mentioned, the base fabric layer of the upper is constructed by the first upper material formed of natural leather and a second upper material formed of a material other than natural leather, and after joining the first and second upper materials, the outer surface of the first and second upper materials is coated with one surface layer formed of resin film. Thereby, even in the event that a variation in appearance quality occurs between a first upper area of the first upper material and a second upper area of the second upper material different from the first upper material, colors/shades or texture/quality between the first and second upper materials can be made equal to each other by coating/covering the outer surface of the base fabric layer by one surface layer formed of resin film. As a result of this, variation in appearance quality between both the upper areas can be prevented. Also, in this case, since a color-matching or a texture-matching is not necessary between the first and second upper materials and all we have to do is to coat the first and second upper materials with a single surface layer formed of resin film, a manufacturing cost can be reduced.

The surface layer may be structured in such a way that the resin film is fixedly attached (e.g. thermocompression-bonded, glued/bonded, etc.) to the outer surface of the first and second upper materials. Thereby, the surface layer is integrated with the first and second upper materials and one leather sheet is structured as a whole.

When fixing the resin film, a sheet that has been treated by an unevenness treatment or processed by a print processing on a surface thereof may be placed on and compressively bonded to the resin film. In this case, by compression-bonding the sheet on the resin film, an evenness or a printing image on a sheet surface is transferred to the resin film. Thereby, an unevenness treatment such as an embossing, a surface texturing, etc. or a print processing can be performed on the surface layer of the upper thus improving an aesthetic appearance of the upper.

### BRIEF DESCRIPTION OF THE DRAWINGS

For a more complete understanding of the invention, reference should be made to the embodiments illustrated in greater detail in the accompanying drawings and described below by way of examples of the invention.

FIG. 1 is a lateral side schematic view of a soccer shoe (for a left foot) employing an upper according to an embodiment of the present invention.

FIG. 2 is a top plan schematic view of the soccer shoe of FIG. 1.

FIG. 3 is a partially enlarged view of FIG. 1.

FIG. 4 is a top plan schematic view of a first upper material and a second upper material in a developed state that constitute a base fabric layer portion of the upper of FIG. 1, illustrating a manufacturing process of the upper of FIG. 1.

FIG. 5 is a top plan schematic view of the first and second upper materials of FIG. 4 in a joined state by stitching, illustrating the manufacturing process of the upper of FIG. 1.

FIG. 6 is a partially enlarged view of FIG. 5.

FIG. 7 is a cross sectional view of FIG. 6 taken along line VII-VII.

FIG. 8 is a top plan schematic view of a surface layer portion of the upper of FIG. 1, illustrating the manufacturing process of the upper of FIG. 1.

FIG. 9 is a top perspective schematic view showing a fixing process in which the surface layer portion of FIG. 8 is fixed by a thermocompression-bonding, etc. on the base fabric layer portion of FIG. 5 in which the first and second upper materials of FIG. 4 are sewed, illustrating the manufacturing process of the upper of FIG. 1.

FIG. 10 is a general perspective view of the upper in a developed state in which an outer surface is coated with a surface layer in the fixing process of FIG. 9.

FIG. 11 is a schematic illustrating a manufacturing process of the upper in time-series manner according to a third variant of the present invention.

FIG. 12 is a schematic illustrating the manufacturing process of the upper in time-series manner according to the third variant of the present invention.

FIG. 13 is a top plan schematic view of the upper in a developed state according to a fourth variant of the present invention.

FIG. 14 is a cross sectional view of FIG. 13 taken along line XIV-XIV.

FIG. 15 is a cross sectional schematic view of the upper according to a fifth variant of the present invention.

### DETAILED DESCRIPTION OF THE PREFERRED EMBODIMENTS

The present invention will now be described in detail with reference to embodiments thereof as illustrated in the accompanying drawings.

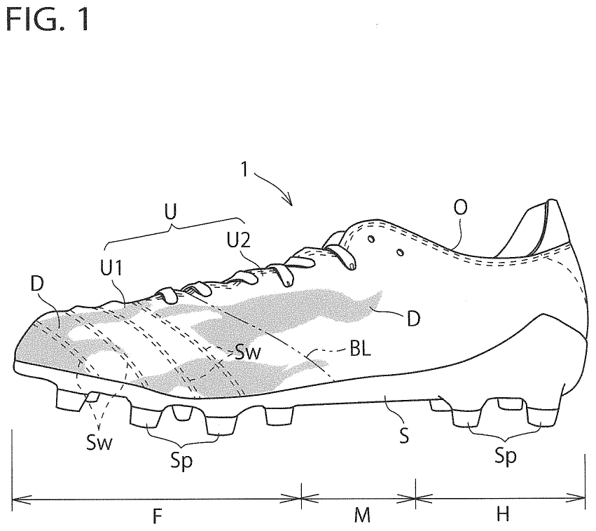

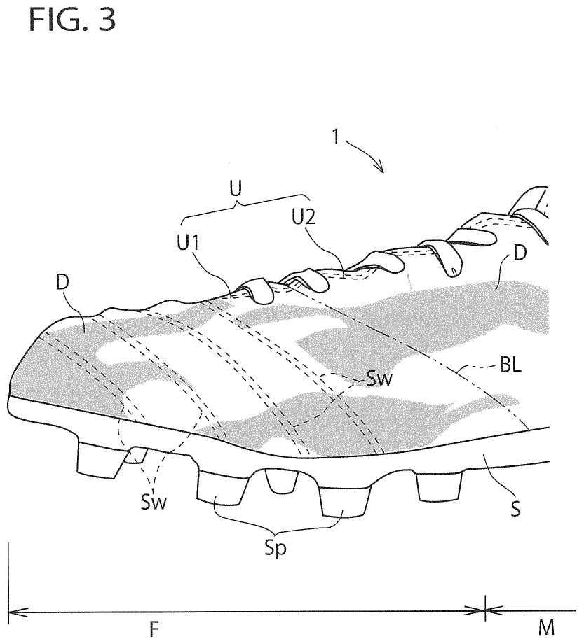

FIGS. 1 to 10 show an upper of a shoe according to an embodiment of the present invention. Here, a soccer shoe is taken for an example. However, the present invention is also applicable to a baseball spike shoe, walking shoe, golf shoe, work shoe, climbing/mountaineering shoe, and the like.

In the following explanation, “upward” and “downward” designate an upward direction and a downward direction, respectively, or vertical direction of the shoe, “forward (front side/front)” and “rearward (rear side/rear)” designate a forward direction and a rearward direction, respectively, or longitudinal direction (i.e. foot-length direction) of the shoe, and “a width or lateral direction” designates a crosswise direction (i.e. foot-width direction) of the shoe.

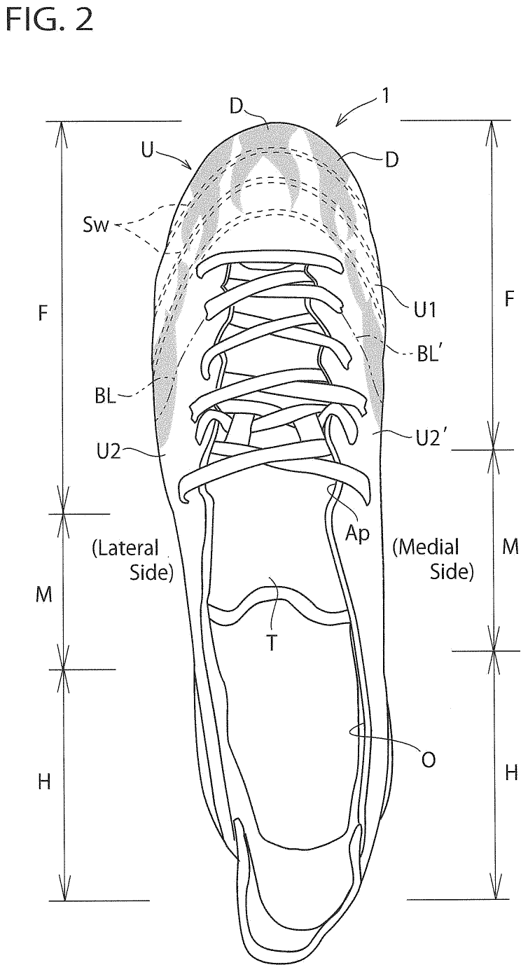

For example, in FIG. 2, a top plan schematic view of the shoe, “upward” and “downward” designate “out of the page” and “into the page” in FIG. 2 respectively; “forward” and “rearward” designate “upward direction” and “downward direction” in FIG. 2 respectively, or a longitudinal direction; and “a width direction” designates “to the left-to-right direction” of FIG. 2, or a lateral direction. Also, in the drawings, reference characters H, M, F designate a heel region, a midfoot region, and a forefoot region of the shoe, respectively. These regions correspond to and are adapted to cover a heel portion, a midfoot portion, and a forefoot portion of a foot of a shoe wearer.

As shown in FIGS. 1 to 3, Soccer shoe 1 includes an upper U that is adapted to cover the foot of the wearer. The upper U extends from the heel region H through the midfoot region M to the forefoot region F of the shoe 1. A bottom portion of the upper U has a bonding margin that corresponds to medial and lateral side portions and a heel rear end portion of a sole 5, respectively. The boding margin of the bottom portion of the upper U is fixedly attached to the sole S by bonding. On a bottom surface of the sole S, a plurality of spikes Sp are provided. At a top portion of the upper U, there are formed an opening O for a foot entry and an aperture Ap extending continuously and longitudinally from the opening O along a top portion of an instep of the upper U. A tongue portion T is provided at the aperture Ap. A front end of the tongue portion T is fixedly attached to an inner portion of the upper U at a front end of the instep portion of the upper U by stitching or the like.

The upper U is composed of a first upper area U1 formed of natural leather and disposed at a region extending from a frontside of a mid-position of the midfoot region M to the forefoot region F, and a second upper area U2, U2′ formed of a material other than natural leather and disposed at a region extending from a rear side of the mid-position of the midfoot region M to the heel region H. The second upper area U2 is disposed on the lateral side of the shoe 1 and the second upper area U2′ is disposed on the medial side of the shoe 1.

In this exemplification, the first upper area U1 is disposed adjacent to the second upper areas U2, U2′ in the longitudinal direction. In the drawings, a double dotted line BL, BL′ designates a boundary between the first upper area U1 and the second upper areas U2, U2′. The boundary line BL indicates the boundary on the lateral side of the shoe 1, and the boundary line BL′ indicates the boundary on the medial side of the shoe 1. Lower ends of the boundary lines BL, BL′ are disposed at the mid-position of the midfoot region M and upper ends of the boundary lines BL, BL′ are disposed at the instep top position of the forefoot region F. The boundary lines BL, BL′ extend diagonally upwardly from the lower ends to the upper ends.

As natural leather for composing the first upper area U1, for example, kangaroo leather, calfskin leather, and the like may be used. As a material other than natural leather for composing the second upper areas U2, U2′, a textile material such as non-woven fabric, knitting, and woven fabric, etc. may be used. On a surface of the upper U, a design D colored in gray may be painted. The design D may be disposed at and across the first and second upper areas U1, U2, U2′. In each of the drawings, a dotted line Sw shows a seam appeared on the surface of the upper U.

The sole S is formed of a hard elastic member, and more specifically, thermoplastic resin such as thermoplastic polyurethane (TPU), polyamide elastomer (PAE), ABS (Acrylonitrile Butadiene Styrene) resin and the like, or thermosetting resin such as epoxy resin and the like. Alternatively, fiber reinforced plastics (CFRP/AFRP/GFRP) may be adopted in which carbon fibers, aramid fibers, glass fibers, respectively, or the like are incorporated as a strengthened fiber and thermosetting resin or thermoplastic resin is incorporated as matrix resin.

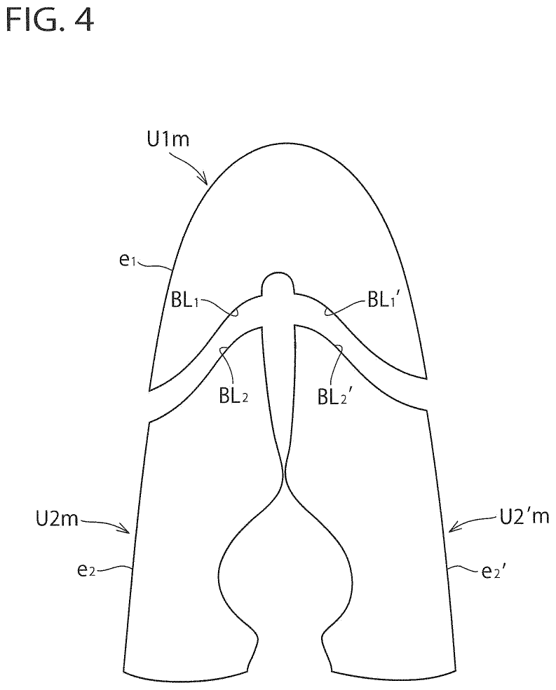

Next, the manufacturing method of the upper U will be explained using FIGS. 4 to 10.

Firstly, as shown in FIG. 4, as a material for composing a base fabric layer for the upper U, we prepare a first upper material U1m formed of natural leather and a pair of second upper materials U2m, U2′m formed of a material other than natural leather, such as a textile material, e.g. non-woven fabric, knitting, woven fabric, etc. On an outer surface of the second upper materials U2m, U2′m to be prepared, a resin layer other than a surface layer formed of a surface material mentioned below is not formed.

Preferably, artificial leather, synthetic leather or the like at the previous stage in which a resin layer is formed on its surface may be used as the second upper materials U2m, U2′m. However, artificial leather, synthetic leather or the like having a resin layer formed thereon may be used by removing the resin layer by means of buffing and the like, alternatively, by performing a substrate treatment by means of applying a primary material and the like to the resin layer. The first upper material U1m to be prepared may be either a material having a grain side layer formed thereon or a material with a grain side removed. The first upper material U1m corresponds to the first upper area U1, and the second upper materials U2m, U2′m correspond to the second upper areas U2, U2′, respectively. In this exemplification, the base fabric layer of the upper U is composed of three upper materials U1m, U2m, U2′m.

The first and second upper materials U1m, U2m, U2′m respectively have an outer peripheral shape greater than that of the first and second upper areas U1, U2, U2′ that correspond to the first and second upper materials U1m, U2m, U2′m, respectively. That is because each of outer peripheral edge portions e₁, e₂, e₂′ of the first and second upper materials U1m, U2m, U2′m has a bonding margin relative to the sole S. Also, lower-side end surfaces BL₁, BL₁′ of the first upper material U1m and upper-side end surfaces BL₂, BL₂′ of the second upper materials U2m, U2′m correspond to the boundary lines BL, BL′ between the first upper area U1 and the second upper areas U2, U2′, respectively.

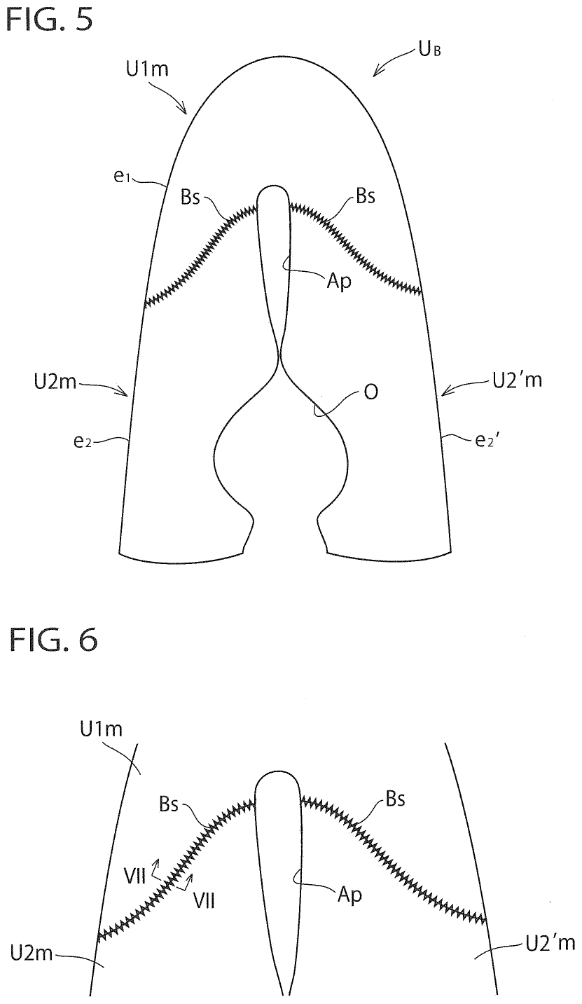

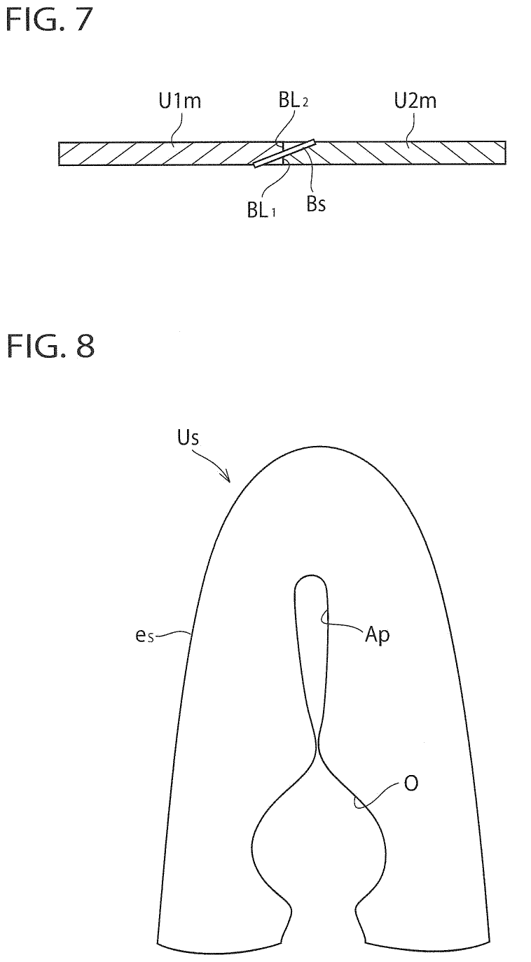

Then, as shown in FIGS. 5 and 6, the first upper material U1m and the second upper materials U2m, U2′m are joined by stitching. At this time, as shown in FIG. 7, the lower-side end surface BL₁ of the first upper material U1m and the upper-side end surface BL₂ of the second upper material U2m are butted or adjoined each other without overlapping and sewn by a sewing thread Bs. Such a sewing method is a “zigzag sewing” without overlapping or stacking (see a position of the sewing thread Bs in FIG. 6), which is also referred to as a butt seaming. The first and second upper materials U1m, U2m, U2′m that have been sewn are formed with opening portions O, Ap which respectively correspond to the opening O and the aperture Ap of the upper U. The first and second upper materials U1m, U2m, U2′m that have been sewn constitute the base fabric layer U_{B} of the upper U.

Then, a surface material to constitute a surface layer of the upper U is prepared. As shown in FIG. 8, a surface material Us has the same shape and size as those of the base fabric layer U_{B} (see FIG. 5) of the upper U. An outer peripheral shape of the surface material Us coincides with the outer peripheral shape of the base fabric layer U_{B}. That is, an outer peripheral edge portion eₛ of the surface material Us coincides with the outer peripheral edge portions e1, e2, e2′ of the first and second upper materials U1m, U2m, U2′m composing the base fabric layer U_{B}. The surface material Us has opening portions O, Ap formed therein that correspond to the opening O and aperture Ap of the upper U. As the surface material Us, for example, a resin film such as polyurethane (PU) film, nylon film and the like may be used. Such a resin film composing the surface material Us is one or a single sheet of film that covers the entire base fabric layer U_{B} of the upper U (i.e. the first and second upper materials U1m, U2m, U2′m). A thickness of the resin film is preferably 0.15 mm or less. Additionally, in FIG. 8, the design D printed on a surface of the surface material Us is omitted for illustration purposes.

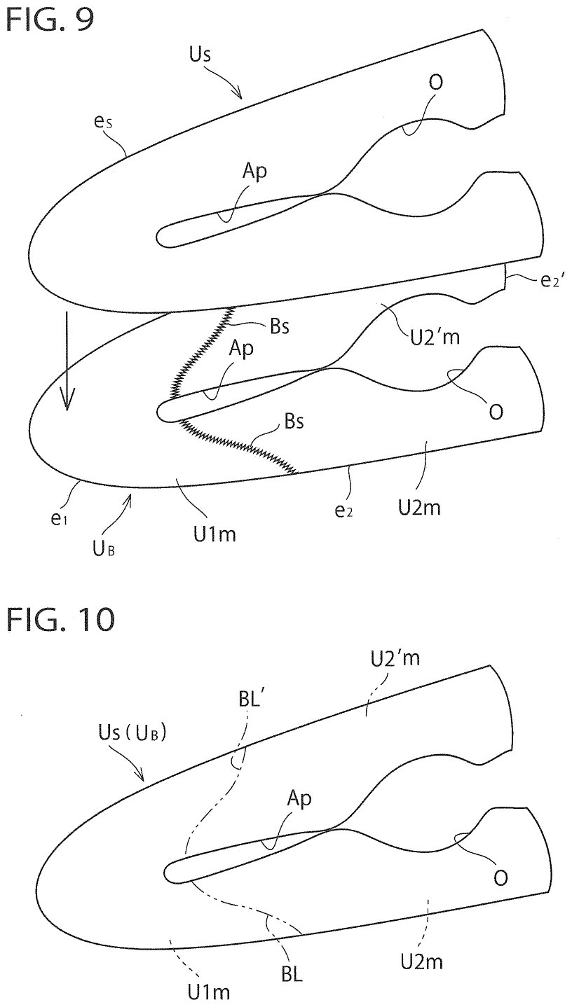

Then, as shown in FIG. 9, the surface material Us is fixedly attached to the outer surface of the base fabric layer U_{B} by overlaying the surface material Us on the base fabric layer U_{B} to thermocompression-bond (or heat-press/hot-press) them, alternatively, applying an adhesive between the base fabric layer U_{B} and the surface material Us. Thereby, as shown in FIG. 10, the outer surface of the base fabric layer U_{B} is coated with one or a single surface layer composed of the surface material Us that covers the entire base fabric layer U_{B} (i.e. the first and second upper materials U1m, U2m, U2′m) to be fixedly attached to the base fabric layer U_{B}. At this juncture, the outer peripheral shape of the surface material Us and thus the surface layer coincides with the outer peripheral shape of the base fabric layer U_{B} and the surface layer composed of the surface material Us is formed on the outer surface of the base fabric layer U_{B}. Thereby, the boundary lines BL, BL′ and the sewing threads Bs of the first and second upper materials U1m, U2m, U2′m composing the base fabric layer U_{B} are hard to be seen from the outside. Especially, in this exemplification, since the design D is printed at a region that spans over the boundary lines BL, BL′ of the first and second upper materials U1m, U2m, U2′m on the surface material Us, the boundary lines BL, BL′ and the sewing threads Bs are hard to be seen from the outside, thus improving a feeling of oneness as an upper.

On the base fabric layer U_{B} coated with the surface layer, necessary parts such as design materials, lining materials, etc. as upper materials are fitted. Thereafter, the base fabric layer U_{B} is pulled over a last for a shoe and bonded to the sole S. In such a manner, the shoe is completed.

As mentioned above, according to the present embodiment, the base fabric layer U_{B} of the upper U is composed of the first upper material U1m formed of natural leather and the second upper materials U2m, U2′m formed of a different material from natural leather, and the outer surface of the base fabric layer U_{B} is coated with one or a single surface layer formed of resin film that covers the first and second upper materials U1m, U2m, U2′m. Thereby, even in the event that variation in appearance quality occurs because the first upper area U1 formed of the first upper material U1m and the second upper areas U2, U2′ formed of the second upper materials U2m, U2′m are constituted by different materials, colors/shades and texture/quality of both the areas U1, U2 can be made equal to each other by coating the outer surface of the base fabric layer U_{B}, i.e. the first and second upper materials U1m, U2m, U2′m, with one or a single surface layer formed of resin film. As a result, variation in appearance quality between the areas U1, U2 can be prevented from occurring. Also, in this case, since it eliminates the necessity for making a color-matching and texture-matching between the first and second upper materials U1m, U2m, U2′m, all we have to do is to cover the first and second upper materials U1m, U2m, U2′m with one or a single surface layer formed of resin film, thus reducing a manufacturing cost.

According to the present embodiment, on the outer surface of the second upper materials U2m, U2′m to be coated with the surface layer, a resin layer other than the surface layer is not formed. Therefore, a fixing strength of the surface layer relative to the outer surface of the second upper materials U2m, U2′m and thus the base fabric layer U_{B} can be increased, thereby preventing separation of the surface layer from the base fabric layer U_{B}.

According to the present embodiment, since the first and second upper materials U1m, U2m, U2′m are butted without overlapping and joined to each other by stitching, the boundary portion between the first and second upper materials U1m, U2m, U2′m can be prevented from becoming hard due to overlapping of the materials U1m, U2m, U2′m. Also, in this case, although the first and second upper materials U1m, U2m, U2′m are not overlapped with each other, the boundary portion of the first and second upper materials U1m, U2m, U2′m is coated with the surface layer, thus improving the bonding strength of the first and second upper materials U1m, U2m, U2′m.

According to the present embodiment, the surface layer is fixedly attached (e.g. by thermocompression-bonded, bonded, etc.) to the outer surface of the base fabric layer U_{B}, that is, the outer surface of the first and second upper materials U1m, U2m, U2′m composing the base fabric layer U_{B}. Therefore, the surface layer is integrated with the base fabric layer U_{B} and thus one leather sheet is composed as a whole.

According to the present embodiment, the outer peripheral shape of the surface layer that coats the base fabric layer U_{B} conforms to the outer peripheral shape of the base fabric layer U_{B}. In this case, the whole outer surface of the first and second upper materials U1m, U2m, U2′m can be coated with the surface layer.

As above-mentioned, a preferred embodiment for the present invention has been described, but the application of the present invention is not limited or restricted to such an embodiment. The present invention includes various variants, or alternative embodiments described below.

### First Variant

In the above-mentioned embodiment, an example was shown in which the boundary lines BL, BL′ between the first upper area U1 and the second upper areas U2, U2′ extend diagonally upwardly at the region extending from the midfoot region M to the forefoot region F on both the medial and lateral sides of the shoe 1, but the application of the present invention is not limited to such an example.

The boundary line BL (as with the boundary line BL′) can be disposed at any other suitable positions and can extend in any other suitable directions. For example, the boundary line BL (as with the boundary line BL′) may be disposed at either one of the forefoot region F, midfoot region M and heel region H, may span over at least two of the forefoot region F, midfoot region M and heel region H, alternatively, may be separately disposed at two regions, for example, at the forefoot region F and the heel region H, excluding the midfoot region M. Also, the boundary line BL (as with the boundary line BL′) may be plural, not one. Moreover, the direction or inclination of the boundary line BL (as with the boundary line BL′) may be vertical or diagonally downward toward a front side of the shoe, not diagonally upward. Additionally, in the above-mentioned embodiment, an example was shown in which the boundary lines BL, BL′ extend diagonally upwardly and gently curve substantially along a diagonally upward direction.

In other words, in the above-mentioned embodiment, an example was shown in which the base fabric layer of the upper U is composed of three upper materials U1m, U2m, U2′m, but the application of the preset invention is not limited to such an example. The base fabric layer of the upper U may be composed of two upper materials. In this case, for example, the second upper materials U2m, U2′m of the above-mentioned embodiment are coupled to each other at either or both the upper portions and the lower portions. Alternatively, the base fabric layer of the upper U may be composed of four or more upper materials.

### Second Variant

In the above-mentioned embodiment, an example was shown in which the outer peripheral shape of the surface material Us that constitutes the surface layer of the upper U coincides with the outer peripheral shape of the base fabric layer U_{B} of the upper U, but the application of the present invention is not restricted to such an example. The outer peripheral shape of the surface material Us may be smaller than the outer peripheral shape of the base fabric layer U_{B}.

In this case, a portion of the outer peripheral shape of the base fabric layer U_{B} that is greater than the outer peripheral shape of the surface material Us can be used as a bonding margin of the upper U relative to the sole S. According to this example, in order to secure the bonding strength of the upper U relative to the sole S, there is no need to perform a buffing treatment relative to the outer peripheral edge portion of the base fabric layer U_{B}, alternatively, a substrate treatment by means of applying a primary material relative to the outer peripheral edge portion of the base fabric layer U_{B}.

### Third Variant

In the above-mentioned embodiment, an example was shown in which the first upper material U1m and the second upper materials U2m, U2′m are joined together by stitching, but the application of the present invention is not restricted to such an example. A joining method of each of the upper materials other than stitching may be a joining by a thin adhesive tape or the like

### Fourth Variant

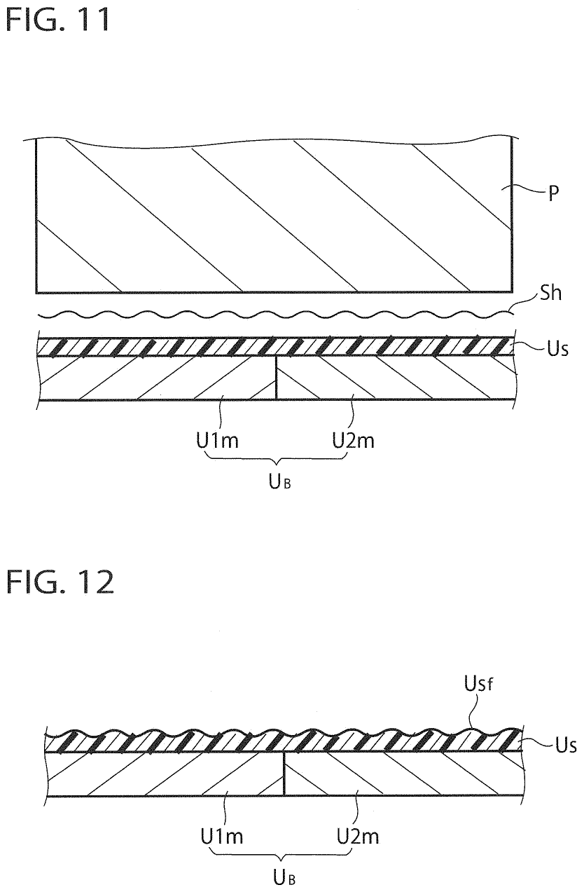

FIGS. 11 and 12 show a manufacturing method of an upper for a shoe according to a fourth variant of the present invention. In these drawings, like reference characters indicate identical or functionally similar elements.

In this fourth variant, as shown in FIG. 11, when fixing the surface material Us on the base fabric layer U_{B} composed of the first and second upper materials U1m, U2m to form a surface layer, a release paper (RP) sheet Sh with an unevenness formed on its surface is prepared. Then, the release paper sheet Sh is placed on the surface material Us and crimped by a press P. After crimping, the release paper sheet Sh is removed from the surface layer.

Then, as shown in FIG. 12, the surface material Us is fixedly attached on the base fabric layer U_{B} to form the surface layer. At the same time, an uneven shape of the release paper sheet Sh is transferred to the surface layer and thus an uneven shape (e.g. emboss-processing or surface texturing, etc.) can be formed on a top surface Usf of the surface layer. In this case, emboss-processing, etc. can be performed on the surface layer through a simple operation without using a large-scale device such as a emboss roller. Also, a feeling of oneness of the entire upper can be improved and aesthetics of the upper can be enhanced. Moreover, the entire upper can be finished to have a natural-leather-like texture by applying a surface texturing like natural leather to the entire surface layer. In addition, a printing process may be performed on the release paper sheet Sh. In this case, after the completion of pressing the release paper sheet Sh, a printing image is transferred to the top surface Usf of the surface layer thereby performing the printing process. Here, an example is shown in which the pressure-bonding or crimping is performed by the press, but crimping may be performed by a vacuum pump.

### Fifth Variant

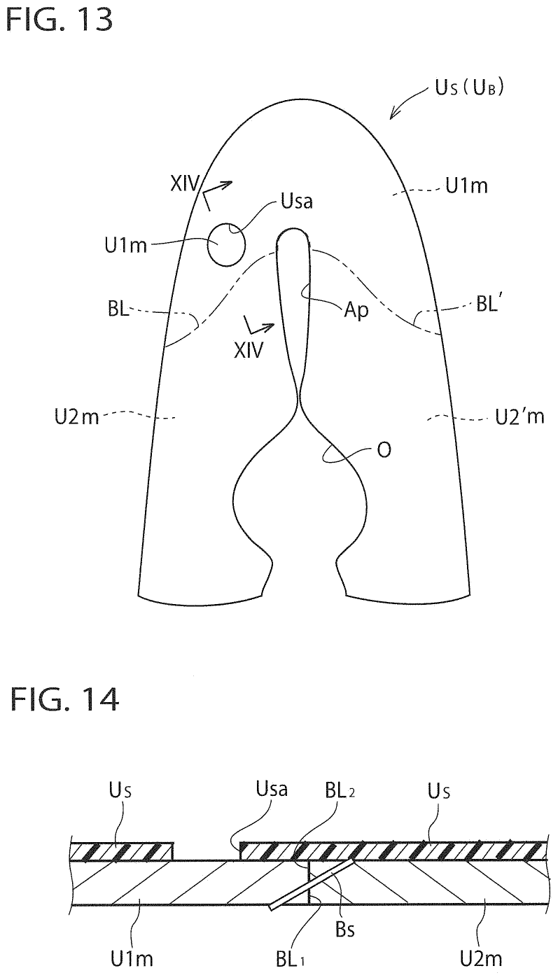

FIGS. 13 and 14 show an upper fora shoe according to a fifth variant of the present invention. FIG. 13 is a top plan schematic view of the upper in a developed state. FIG. 14 is a cross sectional view of FIG. 13 taken along line XIV-XIV. In these drawings, like reference characters indicate identical or functionally similar elements.

In this fifth variant, there is formed an aperture Usa in a portion of the surface material Us that forms the surface layer. The first upper material U1m constituting the base fabric layer U_{B}, located below the surface material Us, is seen through the aperture Usa. In this case, the first upper material U1m formed of natural leather is intentionally faced to the aperture Usa and seen through the aperture Usa from the outside, thereby increasing an appeal force to the customer/purchaser.

### Sixth Variant

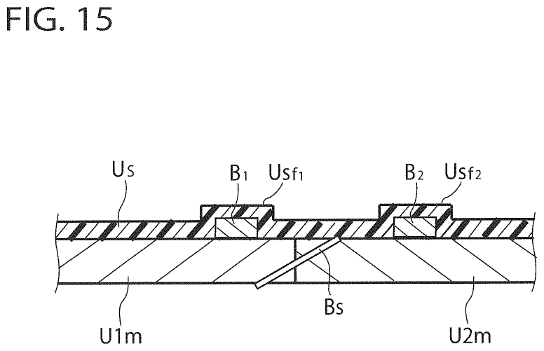

FIG. 15 shows a schematic cross section of an upper for a shoe according to a sixth variant of the present invention. In the drawing, like reference characters indicate identical or functionally similar elements.

In this sixth variant, between the base fabric layer U_{B} and the surface material Us constituting the surface layer, a plurality of (e.g. two) other members B₁, B₂ provided discretely from the surface material Us and the base fabric layer U_{B} are interposed. In a manufacturing process of this upper U, when overlaying the surface material Us on the base fabric layer U_{B} to thermocompression-bond them, by interposing the other members B₁, B₂ between the surface material Us and the base fabric layer U_{B}, the other members B₁, B₂ are inserted between the surface material Us and the base fabric layer U_{B}.

In this case, by inserting the other members B₁, B₂ between the surface material Us and the base fabric layer U_{B}, two protruding portions Usf₁, Usf₂ can be formed on the top surface Usf of the surface layer. By so doing, in a soccer shoe, a provision of such protruding portions Usf₁, Usf₂ on the upper area where a player wants to rotate a soccer ball can cause the ball to rotate effectively.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention.

What is claimed is:

1. An upper for a shoe, wherein said upper is adapted to cover a foot of a shoe wearer and said upper includes a base fabric layer,
said base fabric layer comprising:
a first upper material formed of natural leather and constituting a first upper area; and
a second upper material formed of a material other than natural leather and constituting a second upper area,
wherein said upper further includes a surface layer provided on an outer surface of said base fabric layer, and said surface layer is formed of resin film and covers both said first and second upper materials, whereby said outer surface of said base fabric layer is coated by said surface layer.

2. The upper according to claim 1, wherein a resin layer other than said surface layer is not formed on said outer surface of said second upper material coated with said surface layer.

3. The upper according to claim 1, wherein said first and second upper materials are joined together without overlapping.

4. The upper according to claim 1, wherein said surface layer is fixedly attached to said outer surface of said base fabric layer.

5. The upper according to claim 1, wherein an outer peripheral shape of said surface layer coating said base fabric layer corresponds to an outer peripheral shape of said base fabric layer.

6. The upper according to claim 1, wherein an outer peripheral shape of said surface layer coating said base fabric layer is smaller than an outer peripheral shape of said base fabric layer.

7. The upper according to claim 1, wherein another member is interposed between said surface layer and said outer surface of said base fabric layer.

8. A method for manufacturing an upper for a shoe, wherein said upper is adapted to cover a foot of a shoe wearer and said upper includes a base fabric layer,
said method comprising:
providing a first upper material formed of natural leather and constituting a first upper area and a second upper material formed of a material other than natural leather and constituting a second upper area, such that thereby said first and second upper materials form said base fabric layer;
joining said first and second upper materials together; and
coating an outer surface of said first and second upper materials with a surface layer formed of resin film.

9. The method according to claim 8, wherein said surface layer is structured in such a way that said resin film is fixedly attached to said outer surface of said first and second upper materials.

10. The method according to claim 9, wherein when fixing said resin film a sheet that has been treated by an unevenness treatment or processed by a print processing on a surface thereof is placed on and compressively bonded to said resin film.
